(19) United States
(12) Patent Application Publication
(10) Pub. No.: US 2002/0109925 A1
(43) Pub. Date: Aug. 15, 2002

(54) Objective lens

(76) Inventor: Kazuo Miura, Yokohama-shi (JP)

Correspondence Address: Frommer Lawrence & Haug LLP, 745 Fifth Avenue, New York, NY, 10151, US

(21) Appl. No.: 09/507,283

(22) Filed: Feb. 18, 2000

(30) Foreign Application Priority Data
Feb. 19, 1999 (JP) P11-42408

(51) Int. Cl. G02B 3/02; G02B 13/18; G02B 7/02

(52) U.S. Cl. 359/719; 359/811; 359/819

(57) ABSTRACT

In an objective lens shared by various kinds of optical discs using different wavelengths, damage due to collision between the disc and lens is avoided. A protective member is provided in the entire periphery or in a part of the periphery of a protective protrusion of the objective lens. The protective member may replace the protective protrusion.

### BACKGROUND OF THE INVENTION

1. Field of the Invention

The present invention relates to an objective lens for focussing a plurality of laser beams having different wavelengths onto an optical disc.

2. Description of the Related Art

Nowadays, there are many kinds of optical recording media, including CDs and DVDs. It is to be noted that there is a tendency to use a single objective lens for various kinds of discs, that is, to focus beams on, for example, a CD and a DVD using the same objective lens.

In the case of a CD, a beam having a wavelength of 780 nm is focussed, and in the case of a DVD, a beam having a wavelength of 650 nm is focussed, so that the so-called working distance between the disc and the objective lens differs according to the disc used. The working distance is 1.3 mm for the CD, and 1.7 mm for the DVD.

In the focus servo mechanism for the objective lens, a pick-up 101 moves vertically as the disc 100 moves vertically during rotation due to small warps in the disc 100, as shown in FIG. 1. Apart from the pick-up 101, the servo mechanism includes a feedback circuit comprising a focus error signal detection circuit 102 and a phase compensation drive amplifier 103. The servo mechanism maintains the proper working distance between the objective lens and the disc 100.

As shown in FIG. 2A, the objective lens 101L moves vertically by the excitation of coils 101C. As shown in FIG. 2B, during operation the focus servo maintains the proper working distance by moving the objective lens 101L towards the disc 100 and then moving the objective lens 101L away from the disc 100.

When focus servo moves the objective lens over wide ranges for different working distances, it frequently occurs that the objective lens collides with the back surface of the disc when operating at the smaller working distance. When the objective lens collides with the back surface of the disc, either the objective lens itself or the back surface of the disc is damaged.

### SUMMARY OF THE INVENTION

Accordingly, it is an object of the present invention to provide an objective lens which prevents damage of the lens and the back surface of the disc as a result of collisions.

To achieve the above object, according to a first aspect of the present invention, there is provided an objective lens for focussing a plurality of laser beams having different wavelengths onto an optical disc. The objective lens comprises a lens main body and a protective protrusion integrally formed around the lens main body. The protective protrusion protrudes beyond the apex of the convex surface of the lens main body. At least the portion of the protective protrusion protruding beyond the apex of the convex surface of the lens main body is provided with a protective member.

According to a second aspect of the invention, the protective member is provided at least partially in the periphery of the lens main body.

According to a third aspect of the invention, the protective member is arranged to replace the entire protective protrusion of the lens main body.

According to a fourth aspect of the invention, the protective member is arranged to replace the entire protective protrusion and is provided at least partially in the periphery of the lens main body.

### BRIEF DESCRIPTION OF THE DRAWINGS

FIG. 1 is a block diagram of a focus servomechanism;

FIGS. 2A and 2B are schematic views illustrating the focus servomechanism;

FIGS. 3A, 3B and 3C are sectional views of objective lenses;

FIG. 4 is a schematic view of a disc playback apparatus; and

FIG. 5 is a schematic view of another disc playback apparatus.

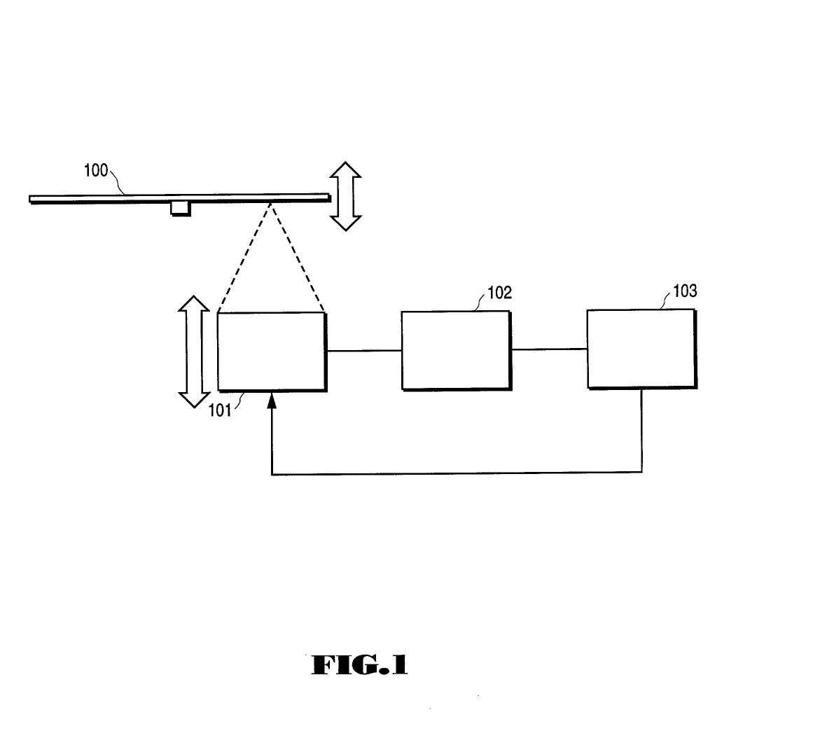

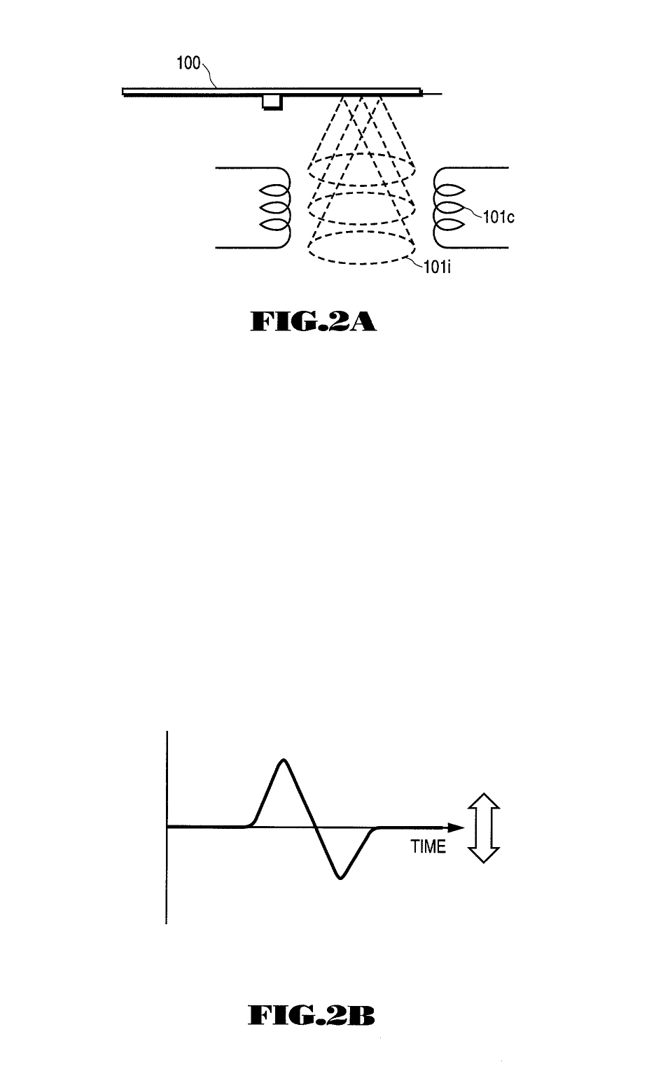

### DESCRIPTION OF THE PREFERRED EMBODIMENT

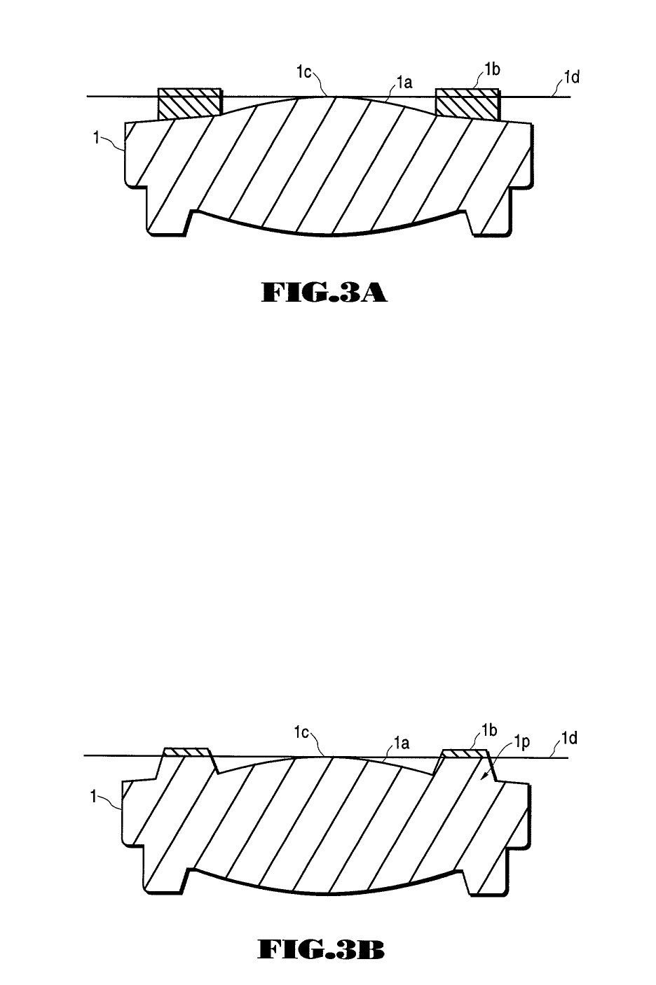

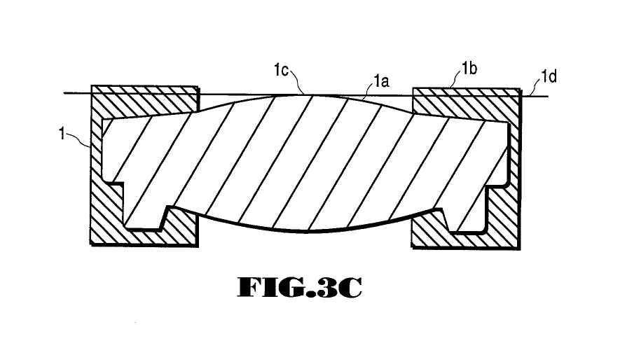

Embodiments of the present invention will now be described with reference to FIGS. 3A through 5. In FIGS. 3A, 3B and 3C, the upper side of the lens is opposed to the back side of the disc. In FIG. 3A, a protective member 1b separate from a lens main body 1a is attached to a peripheral flat surface portion of the lens main body 1a of an objective lens 1 opposed to the back side of the disc.

This protective member 1b is formed as a ring surrounding the lens main body 1a and is high enough so as to protrude beyond a plane 1d which is tangent to the apex of the convex surface 1c of the lens main body 1a.

The protective member 1b is preferably formed of an elastic material having a fixed level of hardness, such as rubber, plastic or other suitable materials. Examples of suitable rubber materials include: natural rubber, butyl, polyurethane Viton™ and other synthetic rubbers. Examples of suitable plastics include: nylon, Teflon, Delrin, Torlon and polycarbonate. Examples of other suitable materials include: cotton, paper and other soft materials.

In FIG. 3B, the top portion of a protective protrusion 1p of the conventional objective lens 1 is cut away, and the protective member 1b is attached to the surface of the portion of the protective protrusion 1p. The protective member 1b protrudes beyond a plane 1d which is tangent to the apex of the convex surface 1c of the lens main body 1a. That is, the protective member 1b is only provided on the protective protrusion 1p surrounding the lens main body 1a. In one embodiment, the protective protrusion 1p is integrally formed with the objective lens 1. The protective member 1b is stacked on top of the protective protrusion 1p. Due to the small working distance between the objective lens 1 and the disk, it is important to minimize the height of the protective member 1b above the apex of the convex surface 1c of the lens main body 1a. If the protective member 1b protrudes to a larger degree than necessary it is liable to collide with the back surface of the disc, which is undesirable. That is, it is undesirable to simply stack the protective member 1b on the protective protrusion 1p well beyond the lens main body 1a since the protective member 1b would forcibly rub against the back surface of the disc. Further, the reproduction of signals would be hindered and the focus mechanism could be damaged since focus servo is constantly operating during the rotation of the disc.

FIG. 3C illustrates an embodiment of the present invention wherein the protective member 1b is formed around the perimeter of the objective lens 1. The protective member 1b may be molded or attached by other means including: bonding, adhesives and melting around the objective lens 1. Again the protective member 1b protrudes beyond a plane 1dwhich is tangent to the apex of the convex surface 1c of the lens main body 1a.

While in the examples shown in FIGS. 3A 3B and 3C the protective member 1b is formed continuously around the lens main body 1a, it is possible in other embodiments to provide a plurality of protective members 1b at equal intervals or unequal intervals in the periphery of the lens main body 1a. In still other embodiments, the protective protrusion 1p is a plurality of equal intervals or unequal intervals in the periphery of the lens main body 1a. The height of the stacked protective member 1b and protective protrusion 1p is the same as the previously described embodiments. Furthermore, even if collision occurs, it is not the protective protrusion 1p but the protective member 1b that collides with the back surface of the disc. This protective member 1b may be formed by applying a protective material to the protective protrusion 1p. Because the protective member 1b is made of a soft material, damage to the lens 1 and disc are substantially reduced as compared with objective lenses not having a protective member 1b.

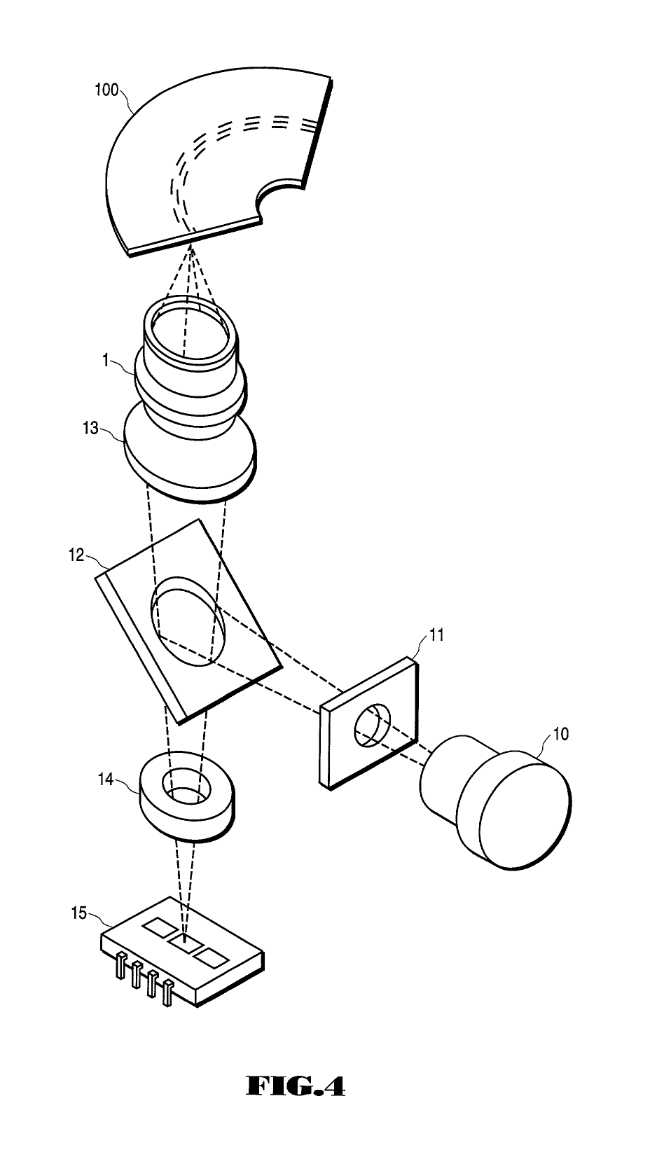

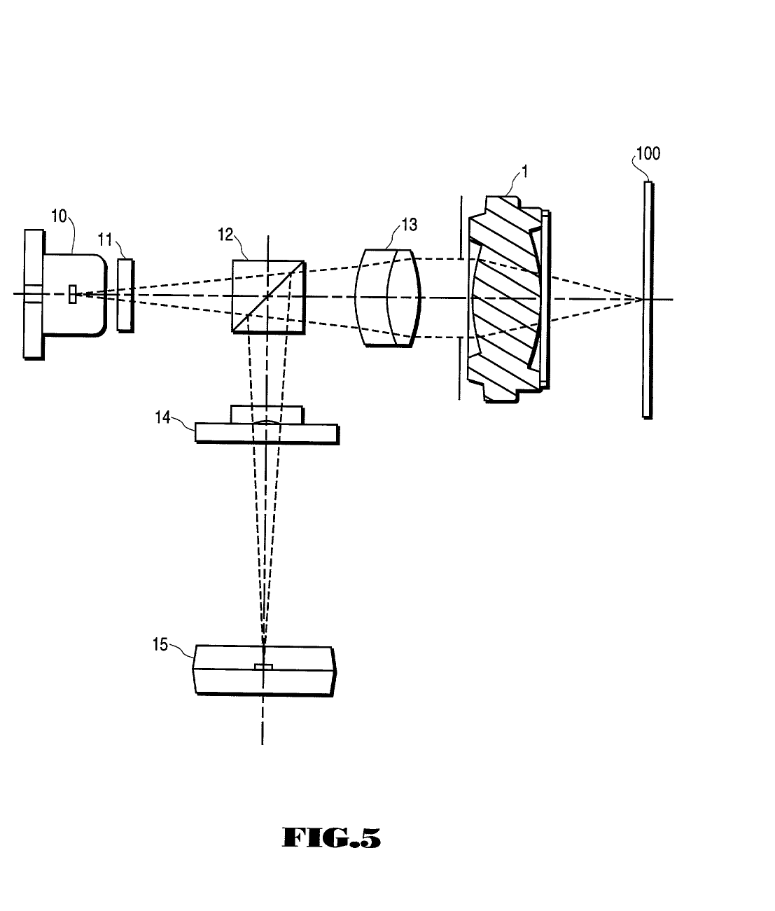

FIGS. 4 and 5 show playback apparatuses for a disc 100 which includes: a laser beam source 10, an aperture, a beam splitter 12, a collimator lens 13, a focusing lens 14, a photodetector 15 and an objective lens 1. The laser beam source 10 can be: a laser diode, a semiconductor laser, or the any other suitable laser source. The beam splitter 12 separates incident light from the laser beam source 10 and reflected light from the disc 100. The collimator lens 13 produces a parallel beam for the objective lens 1. The focussing lens 14 focuses light onto the photodetector 15.

The apparatus shown in FIG. 5 is similar to that shown in FIG. 4 except that in FIG. 5, the incident beam from the laser beam source 10 is transmitted through the beam splitter 12 and the output beam from the disk 100 is reflected by the beam splitter 12. In the apparatus shown in FIG. 4 the incident beam from the laser beam source 10 is reflected by the beam splitter and the output beam from the disk 100 is transmitted through the beam splitter 12. Although not shown in FIGS. 4 and 5, the objective lens 1 has a protective member around the periphery of the lens main body as illustrated in FIGS. 3A, 3B and 3C.

While only three examples are shown in FIGS. 3A, 3B and 3C, various modifications are possible as long as the protective member 1b protrudes beyond a plane 1d tangent to the apex of the convex surface 1c of the lens main body 1a. Further, the objective lens of this embodiment is applicable to any system in which a single objective lens is used to read from and/or write to a plurality of kinds of discs, requiring changes in the focal length and working distance.

As described above, in accordance with the present invention, an objective lens has a protective member on its surface which protects it from colliding with the associated disc, whereby damage to the lens and disc is avoided.

In the foregoing, an objective lens has been described. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. An objective lens for focussing a plurality of laser beams having different wavelengths onto an optical disc, comprising:
a lens with a main body;
a convex surface;
a protective protrusion formed on the lens at least partially around the lens main body; and
a protective member attached to at least a portion of the protective protrusion;
wherein at least a portion of the protective protrusion or of the protective member extends beyond a plane that is tangent to the apex of the lens convex surface.

2. The objective lens of claim 1, wherein:
the protective member is provided at least partially around the periphery of the convex surface.

3. The objective lens of claim 1, wherein: the protective member is made at least partially of rubber.

4. The objective lens of claim 1, wherein:
the protective member is made at least partially of plastic.

5. The objective lens of claim 1, wherein:
the protective protrusion and protective member are substantially circular in shape.

6. The objective lens of claim 1, wherein:
the protective member comprises a multiplicity of segments attached to the protective protrusion.

7. The objective lens of claim 6, wherein:
the protective member is made at least partially of rubber.

8. The objective lens of claim 6, wherein:
the protective member is made at least partially of plastic.

9. An objective lens for focussing a plurality of laser beams having different wavelengths onto an optical disc, comprising:
a lens with a main body;
a convex surface; and
a protective member attached to at least a portion of the lens main body around at least a portion of the periphery of the lens convex surface;
wherein at least a portion of the protective member extends beyond a plane tangent to the apex of the lens convex surface.

10. The objective lens of claim 9, wherein:
the protective member comprises a multiplicity of segments attached around the periphery of the lens convex surface.

11. The objective lens of claim 9, wherein:
the protective member is made at least partially of rubber.

12. The objective lens of claim 9, wherein:
the protective member is made at least partially of plastic.

13. The objective lens of claim 9, wherein:
the protective member is substantially circular in shape.

14. The objective lens of claim 9 wherein:
the protective member is molded to the lens main body.

15. The objective lens of claim 14 wherein:
the protective member is molded to an upper surface and a circumference of the lens main body.

16. The objective lens of claim 10, wherein:
the multiplicity of segments of the protective member are evenly spaced apart.

17. The objective lens of claim 14 wherein:
the protective member is made at least partially of rubber.

18. The objective lens of claim 14 wherein:
the protective member is made at least partially of plastic.

19. A method of protecting an objective lens from damage due to contact with an optical disc comprising the steps of:
providing the objective lens comprising: a lens with a main body and a convex surface; and a protective member attached to the periphery of the lens main body, wherein the protective member intersects a plane tangent to the apex of the lens convex surface;
providing the optical disc which is capable of rotational movement in close proximity to the objective lens; and
contacting the optical disc with the protective member which prevents contact between the optical disc and the lens convex surface.

20. The method of protecting the objective lens of claim 19 wherein:
the protective member is made at least partially of rubber or plastic.
